(19) United States
(12) Patent Application Publication
(10) Pub. No.: US 2002/0030651 A1
(43) Pub. Date: Mar. 14, 2002

(54) Display device and liquid crystal projector

(76) Inventor: Hideki Yamamoto, Kyoto City (JP)

Correspondence Address: ARENT FOX KINTNER PLOTKIN & KAHN, 1050 CONNECTICUT AVENUE, N.W., SUITE 600, WASHINGTON, DC, 20036, US

(21) Appl. No.: 09/930,194

(22) Filed: Aug. 16, 2001

(30) Foreign Application Priority Data
Aug. 23, 2000 (JP) 2000-252865

(51) Int. Cl. G09G 3/36

(52) U.S. Cl. 345/87

(57) ABSTRACT

In a digital device comprising an analog gamma correction circuit, a gamma correction circuit for changing gamma correction characteristics whose input-output characteristics are variable is provided in a stage preceding an analog gamma correction circuit. The input-output characteristics of the gamma correction circuit for changing gamma correction characteristics are changed so that gamma correction characteristics are changed.

### BACKGROUND OF THE INVENTION

1. Field of the Invention

The present invention relates to a display device and a liquid crystal projector.

2. Description of the Prior Art

FIG. 1 illustrates the configuration of a conventional liquid crystal projector comprising an analog gamma correction circuit.

A video signal (AV signal) or a computer signal (CG signal) is inputted to the liquid crystal projector, and either one of the AV signal and the CG signal is selected by an input switching circuit 1 and is fed to an A/D (Analog-to-Digital) converter 2.

An RGB (Red, Green, Blue) signal inputted to the A/D converter 2 is converted into a digital signal by the A/D converter 2, and the digital signal is then fed to a scanning conversion circuit 3. In the scanning conversion circuit 3, digital processing such as frequency conversion is performed. An output signal of the scanning conversion circuit 3 is converted into an analog signal by a D/A (Digital-to-Analog) converter 4, and the analog signal is then subjected to gamma correction by an analog gamma correction circuit 5. An output signal of the analog gamma correction circuit 5 is fed to a sample and hold circuit 6. The signal inputted to the sample and hold circuit 6 is time-division multiplexed and is written into a liquid crystal panel 9, and the written signal is projected on a projection screen.

Each of the units in the liquid crystal projector is controlled by a CPU 8. The CPU 8 comprises a ROM 11 storing its program or the like and a RAM 12 storing necessary data.

A clock fed to the A/D converter 2 and the D/A converter 4, a sampling clock fed to the sample and hold circuit 6, and a panel driving pulse for driving the liquid crystal panel 9 are generated by a timing generator 7.

FIG. 2 illustrates the characteristics of the analog gamma correction circuit 5.

In an example shown in FIG. 2, when a lamp waveform is inputted, the input-output characteristics of the analog gamma correction circuit 5 having one point on the white side (a white-side gamma point γ1), two points on the black side (a black-side gamma point γ2 and a black-side gamma point γ3), and three folded points are illustrated.

Letting a be an AMP (Amplifier) gain between the white level and the folded point γ1, b be an AMP gain between the folded point γ1 and the folded point γ2, c be an AMP gain between the folded point γ2 and the folded point γ3, and d be an AMP point between the folded point γ3 and the black level, the AMP gains a, b, c, and d are determined depending on the voltage-to-transmittance characteristics of the liquid crystal panel.

The folded points γ1, γ2, and γ3 and the AMP gains a, b, c, and d for defining the characteristics of the analog gain correction circuit 5 are stored in the ROM 11, and are fed to the analog gamma correction circuit 5 from the CPU 8. That is, the folded points γ1, γ2, and γ3 and the AMP gains a, b, c, and d for defining the characteristics of the analog gain correction circuit 5 are generally fixed.

The input signal level-to-illuminance characteristics of the liquid crystal projector are characteristics as indicated by a curved line B in FIG. 3 depending on the above-mentioned characteristics of the analog gamma correction circuit 5, to obtain video which visually changes in brightness almost linearly without being blackened or whitened.

Meanwhile, the input signal level-to-illuminance characteristics may, in some cases, be changed depending on the characteristics of an inputted signal, the taste of a user for video, or the like. For example, the input signal level-to-illuminance characteristics may, in some cases, be changed, as indicated by curves A, B, and C shown in FIG. 3.

The curve B shown in FIG. 3 indicates standard input signal level-to-illuminance characteristics which are changed almost linearly from black to white, the curve A shown in FIG. 3 indicates input signal level-to-illuminance characteristics whose half tone looks high, and the curve C shown in FIG. 3 indicates input signal level-to-illuminance characteristics whose half tone conversely looks low .

In order to change the input signal level-to-illuminance characteristics in the conventional circuit, the characteristics of the analog gamma correction circuit must be changed, as shown in FIG. 4. That is, the folded points γ1, γ2, and γ3 and the AMP gains a, b, c, and d must be set. In this case, the values must be set such that white-black level amplitude is not changed.

However, the setting work becomes complicated because it requires a great many steps when the variation in the voltage-to-transmittance characteristics of the liquid crystal panel is considered. If the set value is not matched with the voltage-to-transmittance characteristics of each liquid crystal panel, video is whitened or blackened.

FIG. 7 illustrates the configuration of a conventional liquid crystal projector comprising a digital gamma correction circuit.

A video signal (an AV signal; a composite signal) and a computer signal (a CG signal; an RGB signal) are inputted to the liquid crystal projector. The video signal is converted into an RGB signal by a matrix processing circuit 101, and the RGB signal is then fed to an input switching circuit 102. The computer signal is fed to the input switching circuit 102 as it is. Either one of the output signal of the matrix processing circuit 101 and the CG signal is selected by the input switching circuit 102, and is fed to an A/D converter 103.

The RGB signal inputted to the A/D converter 103 is converted into a digital signal by the A/D converter 103, and the digital signal is then fed to a scanning conversion circuit 104. In the scanning conversion circuit 104, digital processing such as frequency conversion is performed. An output signal of the scanning conversion circuit 104 is subjected to gamma correction by a digital gamma correction circuit 105. The characteristics of the digital gamma correction circuit 105 are set by a CPU 108 on the basis of data stored in the format of a look-up table in a ROM 111.

An output signal of the digital gamma correction circuit 105 is fed to a 12-phase expansion circuit 106. The signal inputted to the 12-phase expansion circuit 106 is time-division multiplexed, and is written into a liquid crystal panel 109. The written signal is projected on a projection screen.

Each of the units in the liquid crystal projector is controlled by the CPU 108. The CPU 108 comprises a ROM 111 storing its program or the like and a RAM 112 storing necessary data.

Furthermore, a clock fed to the A/D converter 103, a timing pulse fed to the 12-phase expansion circuit 106, and a panel driving panel for driving the liquid crystal panel 109 are generated by a timing generator 107.

FIG. 8 illustrates the characteristics of the digital gamma correction circuit 105.

In an example shown in FIG. 8, the input-output characteristics of the digital gamma correction circuit 105 (gamma correction data) in a case where a lamp waveform is inputted are illustrated.

The gamma correction data is determined depending on the voltage-to-transmittance characteristics of the liquid crystal panel 109, and is generally fixed so as to be characteristics as indicated by a curve B in FIG. 8, for example. When the gamma correction data is data as indicated by the curve B in FIG. 8, the input signal level-to-illuminance characteristics of the liquid crystal projector are characteristics as indicated by the curve B in FIG. 3, to obtain video which visually changes in brightness almost linearly without being blackened or whitened.

Meanwhile, the input signal level-to-illuminance characteristics may, in some cases, be changed depending on the characteristics of an inputted signal, the taste of the user for video, or the like. For example, the input signal level-to-illuminance characteristics may, in some cases, be changed, as indicated by the curves A, B, and C shown in FIG. 3.

The curve B in FIG. 3 indicates standard input signal level-to-illuminance characteristics which are changed almost linearly from black to white, the curve A shown in FIG. 3 indicates input signal level-to-illuminance characteristics whose half tone looks high, and the curve C shown in FIG. 3 indicates input signal level-to-illuminance characteristics whose half tone conversely looks low.

In order to change the input signal level-to-illuminance characteristics in three stages indicated by the curves A, B, and C in FIG. 3, for example, in a conventional circuit, the characteristics of the digital gamma correction circuit must be changed in three stages, as indicated by the curves A, B, and C in FIG. 8. Consequently, a look-up table corresponding to the number of stages is required, so that the capacity of a memory storing the look-up table is increased.

The voltage-to-transmittance characteristics of the liquid crystal panel differ among R, G, and B signals. Accordingly, gamma correction data which differs for each of the liquid crystal panels is set. When the gamma correction circuit is changed in a plurality of stages, however, gamma correction data must be produced such that white balance is not changed.

In order to produce the gamma correction data such that the white balance is not changed, the amount of change in digital data must be set for each of the panels while matching the changes in the transmittance among the R, G, and B signals, so that it takes much time to produce the gamma correction data.

### SUMMARY OF THE INVENTION

An object of the present invention is to provide a display device capable of changing gamma correction characteristics without being whitened or blackened and easily changing gamma correction characteristics.

Another object of the present invention is to provide a liquid crystal projector capable of changing gamma correction characteristics (input level-to-illuminance characteristics of a liquid crystal projector) without being whitened or blackened and simply changing the gamma correction characteristics.

In a display device comprising an analog gamma correction circuit, a first display device according to the present invention is characterized in that a gamma correction circuit for changing gamma correction characteristics whose input-output characteristics are variable is provided in a stage preceding the analog gamma correction circuit, and the input-output characteristics of the gamma correction circuit for changing gamma correction characteristics are changed so that gamma correction characteristics are changed.

An example of the gamma correction circuit for changing gamma correction characteristics is one whose input-output characteristics are indicated by an exponential equation whose exponent is variable. It is preferable that an example of the gamma correction circuit for changing gamma correction characteristics is a digital gamma correction circuit.

In a liquid crystal projector comprising an analog gamma correction circuit, a first liquid crystal projector according to the present invention is characterized in that a gamma correction circuit for changing gamma correction characteristics whose input-output characteristics are variable is provided in a stage preceding the analog gamma correction circuit, and the input-output characteristics of the gamma correction circuit for changing gamma correction characteristics are changed so that gamma correction characteristics are changed.

An example of the gamma correction circuit for changing gamma correction characteristics is one whose input-output characteristics are indicated by an exponential equation whose exponent is variable. It is preferable that an example of the gamma correction circuit for changing gamma correction characteristics is a digital gamma correction circuit.

In a display device comprising a digital gamma correction circuit, a second display device according to the present invention is characterized in that a gamma correction circuit for changing gamma correction characteristics whose input-output characteristics are variable is provided in a stage preceding the digital gamma correction circuit, and the input-output characteristics of the gamma correction circuit for changing gamma correction characteristics are changed so that gamma correction characteristics are changed.

An example of the gamma correction circuit for changing gamma correction characteristics is one whose input-output characteristics are indicated by an exponential equation whose exponent is variable. It is preferable that an example of the gamma correction circuit for changing gamma correction characteristics is a digital gamma correction circuit.

In a liquid crystal projector comprising a digital gamma correction circuit, a second liquid crystal projector according to the present invention is characterized in that a gamma correction circuit for changing gamma correction characteristics whose input-output characteristics are variable is provided in a stage preceding the digital gamma correction circuit, and the input-output characteristics of the gamma correction circuit for changing gamma correction characteristics are changed so that gamma correction characteristics are changed.

An example of the gamma correction circuit for changing gamma correction characteristics is one whose input-output characteristics are indicated by an exponential equation whose exponent is variable. An example of the gamma correction circuit for changing gamma correction characteristics is a digital gamma correction circuit.

The foregoing and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is a block diagram showing the configuration of a conventional liquid crystal projector comprising an analog gamma correction circuit;

FIG. 2 is a schematic view showing the characteristics of the analog gamma correction circuit;

FIG. 3 is a graph showing the input signal level-to-illuminance characteristics of the liquid crystal projector;

FIG. 4 is a schematic view showing an example in a case where gamma correction characteristics are changed in the conventional liquid crystal projector;

FIG. 5 is a block diagram showing the configuration of a liquid crystal projector in a first embodiment of the present invention;

FIG. 6 is a graph showing the input-output characteristics of a digital gamma correction circuit for changing gamma correction characteristics;

FIG. 7 is a block diagram showing the configuration of a conventional liquid crystal projector comprising a digital gamma correction circuit;

FIG. 8 is a graph showing the characteristics of the digital gamma correction circuit;

FIG. 9 is a block diagram showing the configuration of a liquid crystal projector in a second embodiment of the present invention.

### DESCRIPTION OF THE PREFERRED EMBODIMENTS

[1] Description of First Embodiment

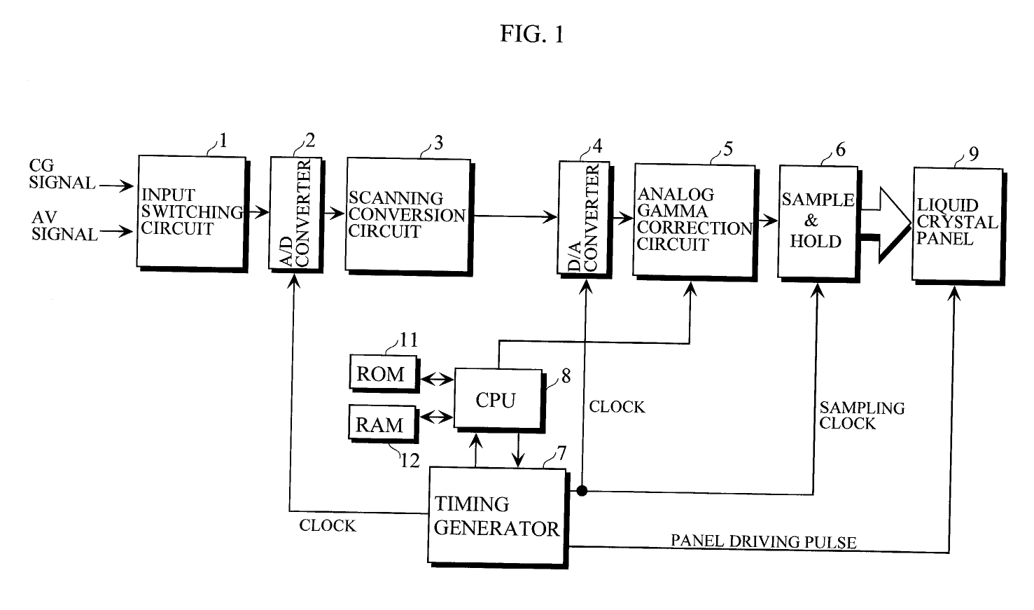

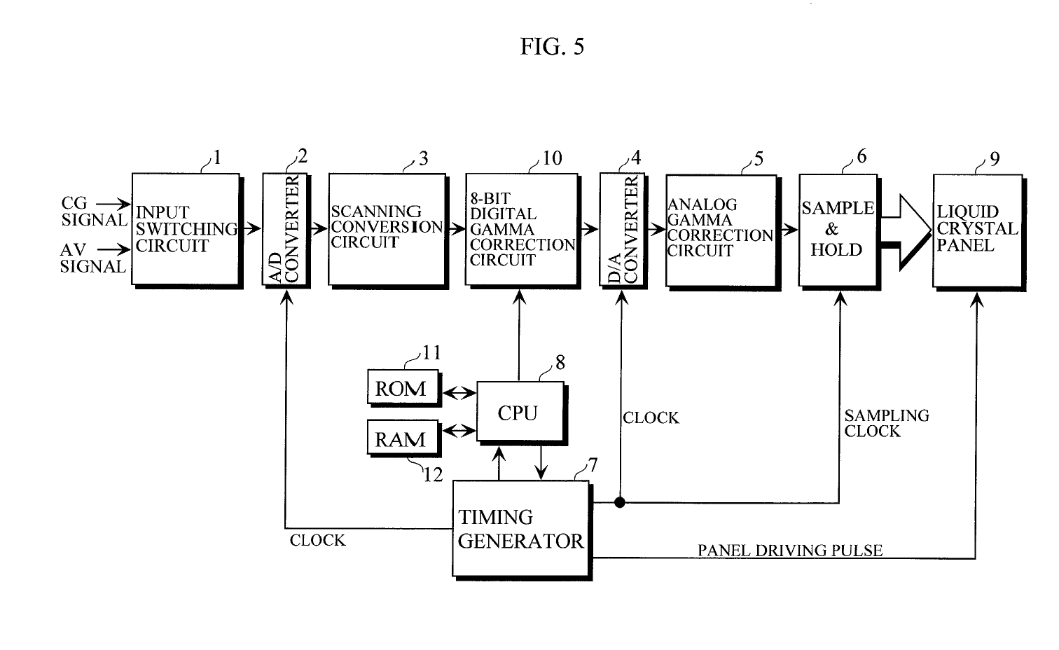

FIG. 5 illustrates the configuration of a liquid crystal projector comprising an analog gamma correction circuit. In FIG. 5, the same units as those shown in FIG. 1 are assigned the same reference numerals and hence, the description thereof is not repeated.

The liquid crystal projector differs from the liquid crystal projector (the conventional circuit) shown in FIG. 1 in that an 8-bit digital gamma correction circuit 10 for changing gamma correction characteristics is provided in a stage preceding a D/A converter 4. Also in the liquid crystal projector, an analog gamma correction circuit 5 is provided in a stage succeeding the D/A converter 4, as in the conventional circuit. In the liquid crystal projector, therefore, gamma correction is performed by the digital gamma correction circuit (preceding-stage gamma correction circuit) 10 and the analog gamma correction circuit (succeeding-stage gamma correction circuit) 5.

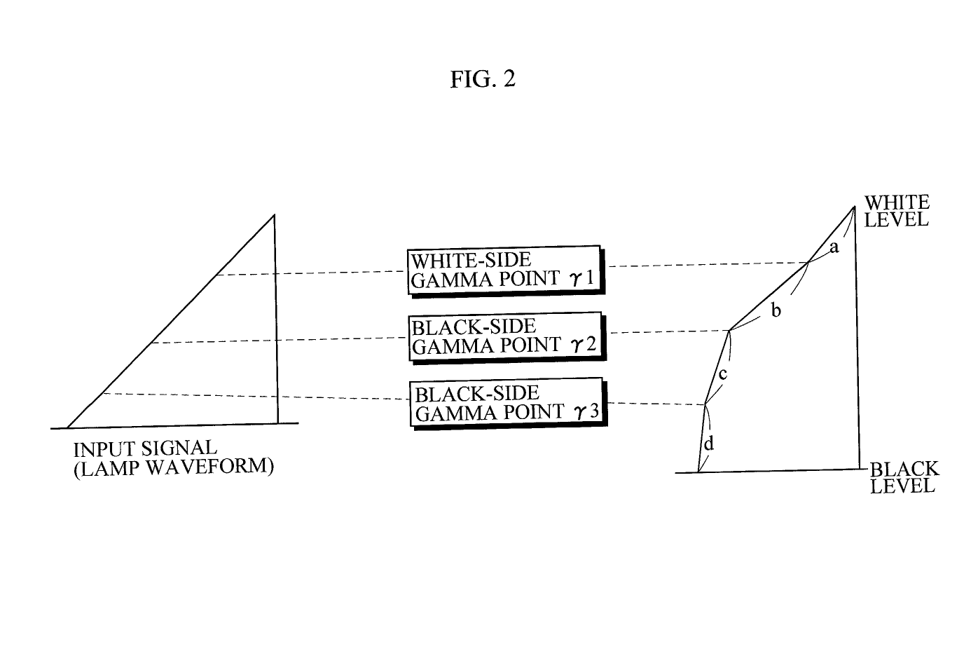

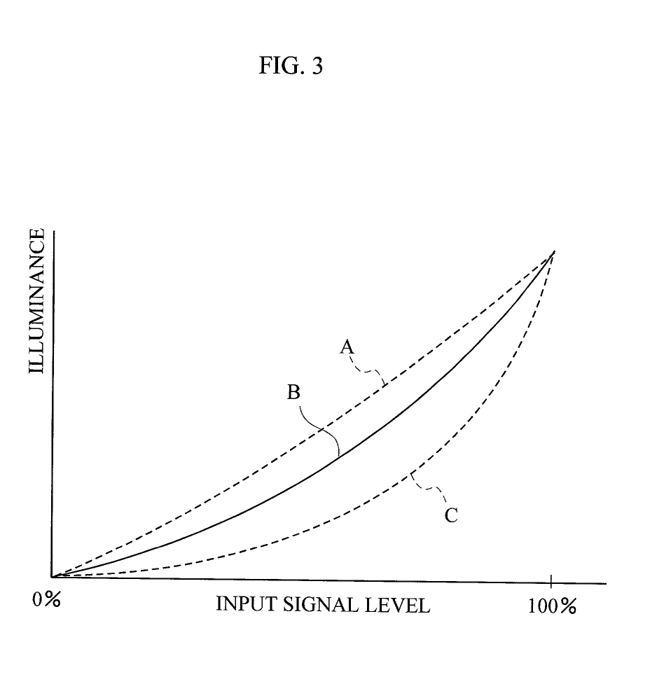

The characteristics of the analog gamma correction circuit 5 (the values of folded points γ1, γ2, and γ3 and AMP gains a, b, c, and d shown in FIG. 2) are fixed such that the input signal level-to-illuminance characteristics of the liquid crystal projector are characteristics as indicated by B in FIG. 3 when the digital gamma correction circuit 10 is not provided, for example.

An example of the digital gamma correction circuit 10 is an 8-bit digital gamma correction circuit having constant signal amplitude and having variable input-output characteristics. The input-output characteristics of the digital gamma correction circuit 10 are switched by control from a CPU 8.

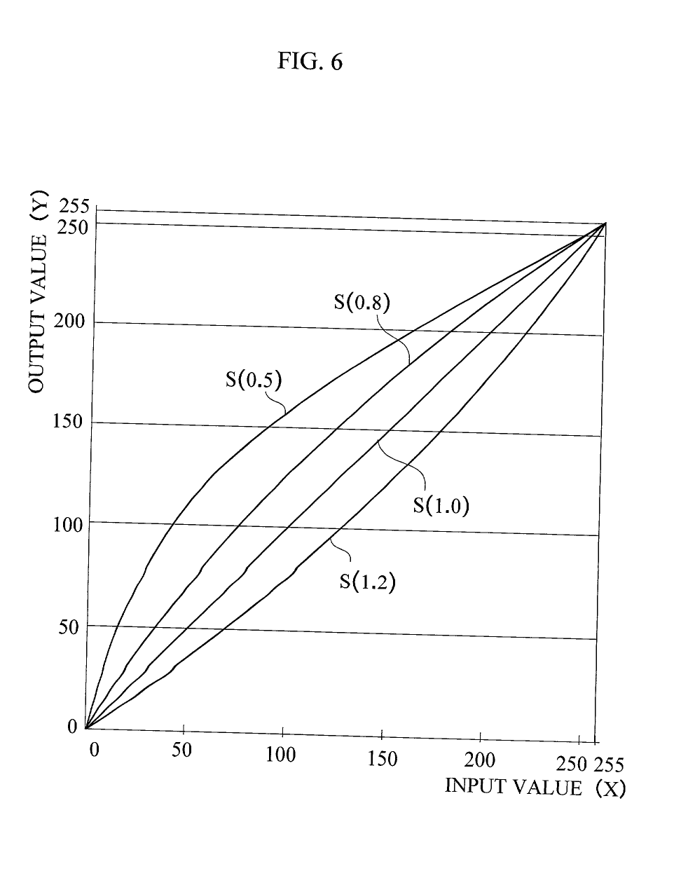

FIG. 6 illustrates a plurality of types of input-output characteristics which can be taken by the digital gamma correction circuit 10.

Letting X be input data of the digital gamma correction circuit 10 and Y be output data thereof, the plurality of types of input-output characteristics which can be taken by the digital gamma correction circuit 10 are indicated by a exponential function expressed by the following equation (1):

Y=255×(X/255)^{a} (1)

The input-output characteristics are changed by changing the value of a in the foregoing equation (1). In this example, a value which differs by 0.1 shall be set in the range of 0.5 to 1.5 as the value of a. That is, a is set to values 0.5, 0.6 . . . 1.0 . . . 1.4, 1.5.

In FIG. 6, a straight line S (1.0) indicates input-output characteristics in a case where a=1.0. Further, a curve S (0.5), a curve S (0.8), and a curve S (1.2) respectively indicate input-output characteristics in a case where a=0.5, input-output characteristics in a case where a=0.8, and input-output characteristics in a case where a=1.2.

The CPU 8 determines the input-output characteristics of the digital gamma correction circuit 10 on the basis of the foregoing equation (1)

When a=1.0, Y=X. The input signal level-to-illuminance characteristics of the liquid crystal projector are standard characteristics as indicated by B in FIG. 3. When the value of a is decreased to 1.0 or less, the input signal level-to-illuminance characteristics of the liquid crystal projector are changed toward A from the characteristics B shown in FIG. 3. Conversely, when the value of a is increased to 1.0 or more, the input signal level-to-illuminance characteristics of the liquid crystal projector are changed toward C from the characteristics B shown in FIG. 3.

That is, in the present embodiment, the CPU 8 switches the input-output characteristics of the digital gamma correction circuit 10 on the basis of an instruction to change characteristics from a user, whereby the input signal level-to-illuminance characteristics of the liquid crystal projector are changed. The input-output characteristics of the digital gamma correction circuit 10 can be switched on the basis of simple calculation as expressed by the foregoing equation (1).

The present embodiment has the following advantages because the gamma correction characteristics are changed by changing the input-output characteristics of the digital gamma correction circuit 10, to change the input signal level-to-illuminance characteristics of the liquid crystal projector.

That is, when the gamma correction characteristics are converted, amplitude between white and black of a signal outputted from the D/A converter 4 is not changed, so that the amplitude between white and black of the waveform of an output signal of the analog gamma correction circuit 5 is not changed, so that video is not whitened or blackened.

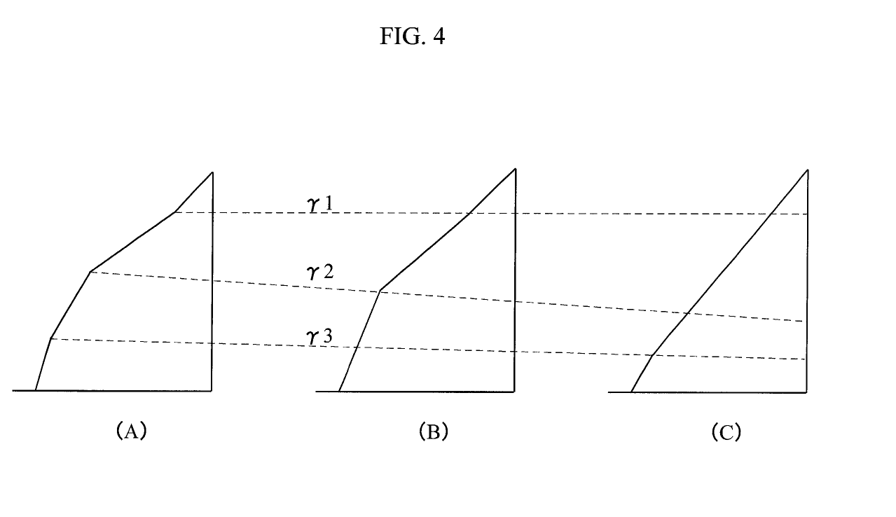

It is considered that the gamma correction characteristics as shown in FIG. 4 are changed using only the 8-bit digital gamma correction circuit without using an analog gamma correction circuit. Since the number of bits processed by the digital gamma correction circuit is small, however, contour line noise is liable to be produced on the side of black in which the inclination of the correction characteristics is large.

Contrary to this, in the present embodiment, the digital gamma correction circuit 10 and the analog gamma correction circuit 5 are simultaneously used, and the digital gamma correction circuit 10 is used for converting an input-output level on the basis of input-output characteristics which are smoothly changed, as shown in FIG. 6. Accordingly, contour line noise is not easily produced, thereby making it possible to use a low-cost digital gamma correction circuit composed of a small number of bits.

An analog gamma correction circuit may be used as a preceding-stage gamma correction circuit. In the case, even if the input-output characteristics as shown in FIG. 6 are changed in order to prevent video from being whitened or blackened, however, the amplitude between white and black is not changed in the circuit.

[2] Description of Second Embodiment

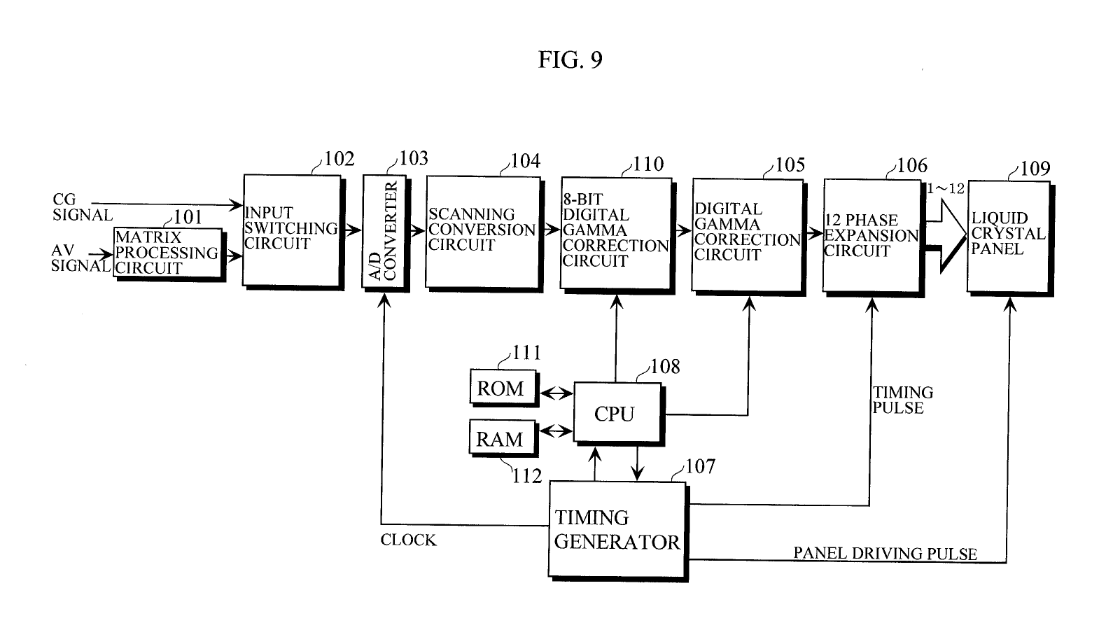

FIG. 9 illustrates the configuration of a liquid crystal projector comprising a digital gamma correction circuit.

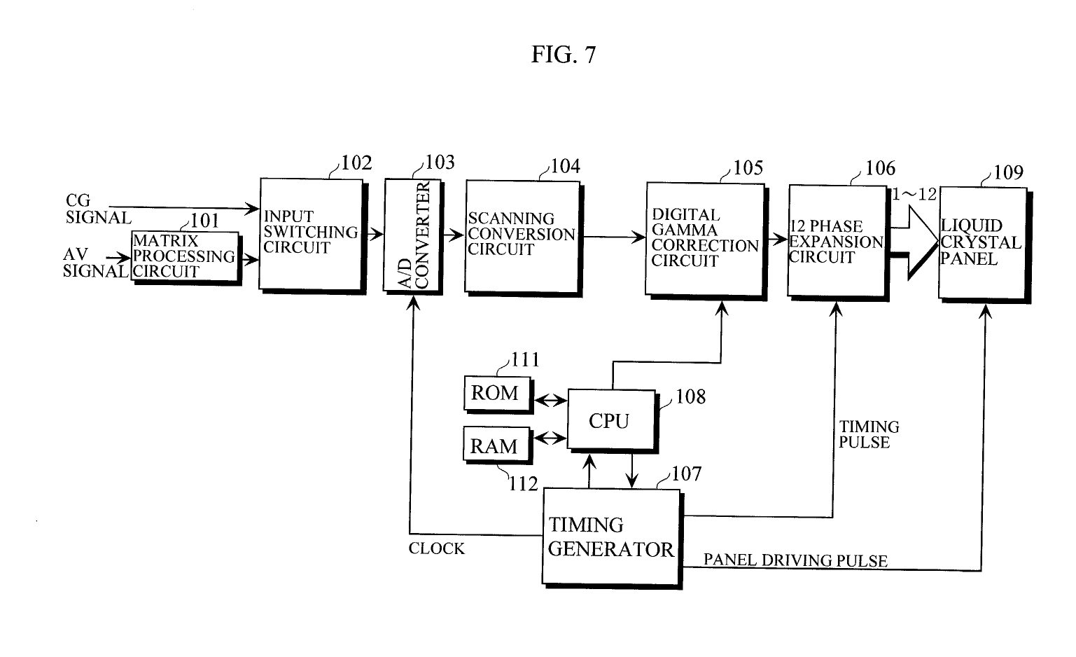

In FIG. 9, the same units as those shown in FIG. 7 are assigned the same reference numerals and hence the description thereof is not repeated.

The liquid crystal projector differs from the liquid crystal projector (the conventional circuit) shown in FIG. 7 in that an 8-bit digital gamma correction circuit 110 for changing gamma correction characteristics is provided in a stage preceding an original digital gamma correction circuit 105. In the liquid crystal projector, gamma correction is performed by the 8-bit digital gamma correction circuit (a preceding-stage gamma correction circuit: hereinafter referred to as a sub-gamma correction circuit) 110 and the digital gamma correction circuit (a succeeding-stage gamma correction circuit: hereinafter referred to as a main gamma correction circuit) 105.

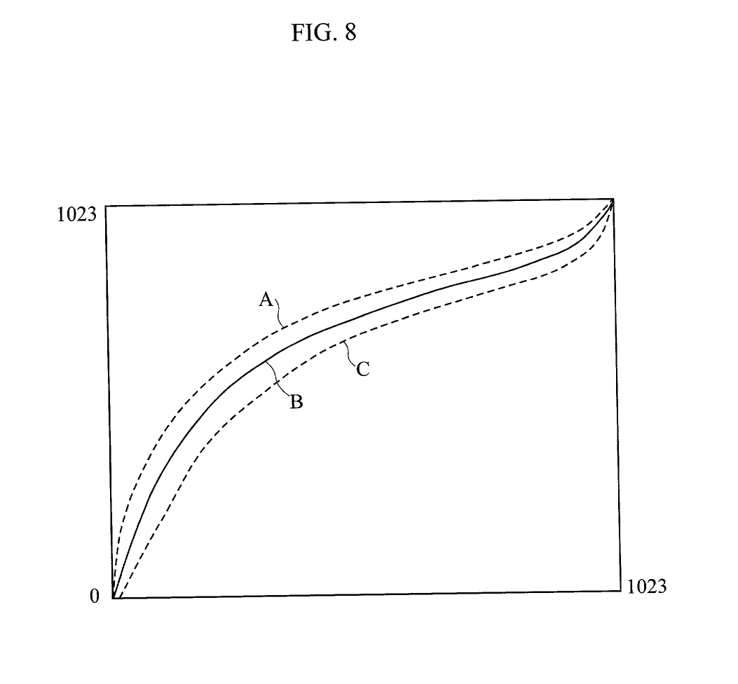

The characteristics of the main gamma correction circuit 105 are fixed such that the input signal level-to-illuminance characteristics of the liquid crystal projector are characteristics as indicated by B in FIG. 3 when the sub-gamma correction circuit 110 is not provided, for example. That is, the characteristics of the main gamma correction circuit 105 are fixed to characteristics as indicated by B in FIG. 8.

As the sub-gamma correction circuit 110, an 8-bit digital gamma correction circuit whose input-output characteristics are variable with the signal amplitude being constant is used, similarly to the digital gamma correction circuit 10 in the first embodiment. The input-output characteristics of the sub-gamma correction circuit 110 are switched by control from the CPU 108.

FIG. 6 illustrates a plurality of types of input-output characteristics which can be taken by the sub-gamma correction circuit 110.

Letting X be input data of the sub-gamma correction circuit 110 and Y be output data thereof, the plurality of types of input-output characteristics which can be taken by the sub-gamma correction circuit 110 are indicated by a exponential function expressed by the following equation (2):

Y=255×(X/255)^{a} (2)

The input-output characteristics are changed by changing the value of a in the foregoing equation (2). In this example, values which differ by 0.1 shall be set in the range of 0.5 to 1.5 as the value of a. That is, a is set to values 0.5, 0.6, . . . 1.0 . . . 1.4, 1.5.

In FIG. 6, a straight line S (1.0) indicates input-output characteristics in a case where a=1.0. Further, a curve S (0.5), a curve S (0.8), and a curve S (1.2) respectively indicate input-output characteristics in a case where a=0.5, input-output characteristics in a case where a=0.8, and input-output characteristics in a case where a=1.2.

The CPU 8 determines the input-output characteristics of the sub-gamma correction circuit 110 on the basis of the foregoing equation (2).

When a=1.0, Y=X. The input signal level-to-illuminance characteristics of the liquid crystal projector are standard characteristics indicated by B in FIG. 3. When the value of a is decreased to 1.0 or less, the input signal level-to-illuminance characteristics of the liquid crystal projector are changed toward A from the characteristics B shown in FIG. 3. Conversely, when the value of a is increased to 1.0 or more, the input signal level-to-illuminance characteristics of the liquid crystal projector are changed toward C from the characteristics B shown in FIG. 3.

That is, in the present embodiment, the CPU 108 switches the input-output characteristics of the sub-gamma correction circuit 110 on the basis of an instruction to change characteristics from a user, whereby the input signal level-to-illuminance characteristics of the liquid crystal projector are changed. The input-output characteristics of the sub-gamma correction circuit 110 can be switched on the basis of a simple calculating equation as expressed by the foregoing equation (2).

If proper values are set for respective R, G, and B liquid crystal panels as gamma correction data for the main gamma correction circuit 105, white balance is not changed even if the input-output characteristics of the sub-gamma correction circuit 110 in the preceding stage are changed.

According to the second embodiment, the gamma correction characteristics can be switched into a plurality of stages by switching the input-output characteristics of the sub-gamma correction circuit 110. The input-output characteristics of the sub-gamma correction circuit 110 can be switched on the basis of a simple calculating equation, whereby the gamma correction characteristics are simply switched.

That is, according to the second embodiment, in order to switch the gamma correction characteristics into a plurality of stages, a plurality of types of gamma correction data need not be prepared as gamma correction data for the main gamma correction circuit. Accordingly, the gamma correction data for the main gamma correction circuit is easily produced, and the capacity of a memory storing the gamma correction data can be reduced.

Although the present invention has been described and illustrated in detail, it is clearly understood that the same is by way of illustration and example only and is not to be taken by way of limitation, the spirit and scope of the present invention being limited only by the terms of the appended claims.

What is claimed:

1. A display device comprising an analog gamma correction circuit, wherein
a gamma correction circuit for changing gamma correction characteristics whose input-output characteristics are variable is provided in a stage preceding the analog gamma correction circuit, and the input-output characteristics of the gamma correction circuit for changing gamma correction characteristics are changed so that gamma correction characteristics are changed.

2. The display device according to claim 1, wherein
the input-output characteristics of the gamma correction circuit for changing gamma correction characteristics are indicated by an exponential equation whose exponent is variable.

3. The display device according to claim 1, wherein
the gamma correction circuit for changing gamma correction characteristics is a digital gamma correction circuit.

4. The display device according to claim 2, wherein
the gamma correction circuit for changing gamma correction characteristics is a digital gamma correction circuit.

5. A liquid crystal projector comprising an analog gamma correction circuit, wherein
a gamma correction circuit for changing gamma correction characteristics whose input-output characteristics are variable is provided in a stage preceding the analog gamma correction circuit, and the input-output characteristics of the gamma correction circuit for changing gamma correction characteristics are changed so that gamma correction characteristics are changed.

6. The liquid crystal projector according to claim 5, wherein
the input-output characteristics of the gamma correction circuit for changing gamma correction characteristics are indicated by an exponential equation whose exponent is variable.

7. The liquid crystal projector according to claim 5, wherein
the gamma correction circuit for changing gamma correction characteristics is a digital gamma correction circuit.

8. The liquid crystal projector according to claim 6, wherein
the gamma correction circuit for changing gamma correction characteristics is a digital gamma correction circuit.

9. A display device comprising a digital gamma correction circuit, wherein
a gamma correction circuit for changing gamma correction characteristics whose input-output characteristics are variable is provided in a stage preceding the digital gamma correction circuit, and the input-output characteristics of the gamma correction circuit for changing gamma correction characteristics are changed so that gamma correction characteristics are changed.

10. The display device according to claim 9, wherein
the input-output characteristics of the gamma correction circuit for changing gamma correction characteristics are indicated by an exponential equation whose exponent is variable.

11. The display device according to claim 9, wherein
the gamma correction circuit for changing gamma correction characteristics is a digital gamma correction circuit.

12. The display device according to claim 10, wherein
the gamma correction circuit for changing gamma correction characteristics is a digital gamma correction circuit.

13. A liquid crystal projector comprising a digital gamma correction circuit, wherein
a gamma correction circuit for changing gamma correction characteristics whose input-output characteristics are variable is provided in a stage preceding the digital gamma correction circuit, and the input-output characteristics of the gamma correction circuit for changing gamma correction characteristics are changed so that gamma correction characteristics are changed.

14. The liquid crystal projector according to claim 13, wherein
the input-output characteristics of the gamma correction circuit for changing gamma correction characteristics are indicated by an exponential equation whose exponent is variable.

15. The liquid crystal projector according to claim 13, wherein
the gamma correction circuit for changing gamma correction characteristics is a digital gamma correction circuit.

16. The liquid crystal projector according to claim 14, wherein
the gamma correction circuit for changing gamma correction characteristics is a digital gamma correction circuit.
